(19) United States
(12) Patent Application Publication
(10) Pub. No.: US 2025/0367548 A1
(43) Pub. Date: Dec. 4, 2025

(54) Control Bifurcation Methods and Systems for Multi-Player Gaming

(71) Applicant: Shaga Labs, Inc., Dover, DE (US)

(72) Inventor: Guido Rocco Pardini, Viareggio Lucca (IT)

(21) Appl. No.: 19/223,173

(22) Filed: May 30, 2025

Related U.S. Application Data
(60) Provisional application No. 63/653,248, filed on May 30, 2024.

(51) Int. Cl. A63F 13/355

(52) U.S. Cl. CPC A63F 13/355

(57) ABSTRACT

A control bifurcation method and system for multi-player game streaming including: at a light client edge device, copying and signing a control signal and a sending a signed copy of the control signal to each of a local personal computer (PC) rendering a game and a remote multi-player server updating a global game state of the game using control signals from a plurality of gamers; and, at the multi-player server, updating the global game state of the game using one of the signed copy of the control signal received from the light client edge device and a signed copy of the control signal received from the PC that is received first, and disregarding and discarding one of the signed copy of the control signal received from the light client edge device and the signed copy of the control signal received from the PC that is received second.

### CROSS-REFERENCE TO RELATED APPLICATION

The present disclosure claims the benefit of priority of co-pending U.S. Provisional Patent Application No. 63/653,248, filed on May 30, 2024, and entitled “Control Bifurcation Methods and Systems for Multi-Player Gaming,” the contents of which are incorporated in full by reference.

### TECHNICAL FIELD

The present disclosure relates generally to the multi-player gaming field. More particularly, the present disclosure relates to control bifurcation methods and systems for multi-player gaming.

### BACKGROUND

“Unoptimized latency” is a persistent problem in state-of-the-art multi-player game streaming scenarios, where control signals take unnecessary hops to travel from a light client edge device where a game is played first to a local processing device (e.g., personal computer (PC)) where the game is running, and then later to a remote multi-player server where game events are sequenced, and then finally broadcasted from the multi-player server to the various players in a session.

Conventionally, this has not always been an issue because the PCs used in cloud gaming services typically use data centers that are relatively close to (sometimes even collocated with) the computers where the multi-player servers are run. However, the problem is significant with evolving approaches, where PCs belonging to people render the games (in edge gaming); since remote data centers are still relied on for the multi-player servers. The latency issue is more perceivable because of the distance between the rendering PC and the computer where the multi-player server is running. Thus, player-to-player (P2P) edge gaming now makes unoptimized latency a significant issue.

The present background is provided as illustrative environmental context only. It will be readily apparent to those of ordinary skill in the art that the principles and concepts of the present disclosure may be implemented in other environmental contexts equally, without limitation. For example, although gaming is specifically mentioned, other similar multi-user edge computing applications are also contemplated.

### SUMMARY

The present disclosure provides control bifurcation methods and systems that utilize duplicated control signals for game streaming, sending one copy from a light client edge device that is playing a game to the local PC that is rendering the game and one copy directly to the remote multi-player server where other players are sending their actions to be sequenced. The local PC that is rendering the game also sends the control signal to the remote multi-player server. The remote multi-player server generates global game state updates with whichever copy of the control signals is received first, either from the light client edge device directly or from the local PC that is rendering the game, discarding any subsequently received duplicate control signal. Control signal latency is thereby minimized. Duplicate control signals are identified based on common control signal signatures that are added to the packet overhead of each control signal at the light client edge device via a game streaming control signal signature application executed at the light client edge device.

In this manner, the control bifurcation method and system eliminate delay by, when faster, enabling control signals to be sent directly from the client, where the gamer is playing, to the multi-player server, when faster, bypassing the need to first transmit these control signals to the PC, where the game is rendered, and then the multi-player server for global game state updates, when slower.

In one embodiment, the present disclosure provides a control bifurcation method for multi-player game streaming including, at a light client edge device, copying and signing a control signal and sending signed copies of the control signal directly to a remote processing device updating a global game state of a game and indirectly to the remote processing device through a local processing device rendering the game, and, at the remote processing device, updating the global game state of the game using one of the signed copies of the control signal received directly from the light client edge device or indirectly from the light client edge device through the local processing device that is received first and disregarding another of the signed copies of the control signal received directly from the light client edge device or indirectly from the light client edge device through the local processing device that is received second. The control signal is received at the light client edge device from an input peripheral coupled to the light client edge device. In some embodiments, the local processing device is a personal computer. In some embodiments, the remote processing device is a multi-player server. The remote processing device updates the global game state of the game using the one of the signed copies of the control signal received directly from the light client edge device or indirectly from the light client edge device through the local processing device that is received first and one or more sequenced control signals received from one or more other gaming devices coupled to the remote processing device and/or the local processing device. The control bifurcation method also includes, at the remote processing device, determining that the signed copies of the control signal received directly from the light client edge device and indirectly from the light client edge device through the local processing device are copies based on a comparison of packet headers inserted into the signed copies of the control signal received directly from the light client edge device and indirectly from the light client edge device through the local processing device by a game streaming application running in the light client edge device. The control bifurcation method further includes, at the remote processing device, determining that the one of the signed copies of the control signal received directly from the light client edge device or indirectly from the light client edge device through the local processing device is received first based on a comparison of arrival times at the remote processing device of the signed copies of the control signal received directly from the light client edge device and indirectly from the light client edge device through the local processing device.

In another embodiment, the present disclosure provides a control bifurcation system for multi-player game streaming including a light client edge device operable for copying and signing a control signal and sending signed copies of the control signal directly to a remote processing device updating a global game state of a game and indirectly to the remote processing device through a local processing device rendering the game, and the remote processing device operable for updating the global game state of the game using one of the signed copies of the control signal received directly from the light client edge device or indirectly from the light client edge device through the local processing device that is received first and disregarding another of the signed copies of the control signal received directly from the light client edge device or indirectly from the light client edge device through the local processing device that is received second. The control bifurcation system also includes an input peripheral coupled to the light client edge device and operable for generating the control signal and sending the control signal to the light client edge device. In some embodiments, the local processing device is a personal computer. In some embodiments, the remote processing device is a multi-player server. The remote processing device is further operable for updating the global game state of the game using the one of the signed copies of the control signal received directly from the light client edge device or indirectly from the light client edge device through the local processing device that is received first and one or more sequenced control signals received from one or more other gaming devices coupled to the remote processing device and/or the local processing device. The remote processing device is further operable for determining that the signed copies of the control signal received directly from the light client edge device and indirectly from the light client edge device through the local processing device are copies based on a comparison of packet headers inserted into the signed copies of the control signal received directly from the light client edge device and indirectly from the light client edge device through the local processing device by a game streaming application running in the light client edge device. The remote processing device is further operable for determining that the one of the signed copies of the control signal received directly from the light client edge device or indirectly from the light client edge device through the local processing device is received first based on a comparison of arrival times at the remote processing device of the signed copies of the control signal received directly from the light client edge device and indirectly from the light client edge device through the local processing device.

In a further embodiment, the present disclosure provides a non-transitory computer-readable medium including instructions stored in a memory and executed by a processor to carry out steps of a control bifurcation method for multi-player game streaming including, at a light client edge device, copying and signing a control signal and sending signed copies of the control signal directly to a remote processing device updating a global game state of a game and indirectly to the remote processing device through a local processing device rendering the game, and, at the remote processing device, updating the global game state of the game using one of the signed copies of the control signal received directly from the light client edge device or indirectly from the light client edge device through the local processing device that is received first and disregarding another of the signed copies of the control signal received directly from the light client edge device or indirectly from the light client edge device through the local processing device that is received second. The control signal is received at the light client edge device from an input peripheral coupled to the light client edge device. In some embodiments, the local processing device is a personal computer and the remote processing device is a multi-player server. The remote processing device updates the global game state of the game using the one of the signed copies of the control signal received directly from the light client edge device or indirectly from the light client edge device through the local processing device that is received first and one or more sequenced control signals received from one or more other gaming devices coupled to the remote processing device and/or the local processing device. The steps further include, at the remote processing device, determining that the signed copies of the control signal received directly from the light client edge device and indirectly from the light client edge device through the local processing device are copies based on a comparison of packet headers inserted into the signed copies of the control signal received directly from the light client edge device and indirectly from the light client edge device through the local processing device by a game streaming application running in the light client edge device. The steps further include, at the remote processing device, determining that the one of the signed copies of the control signal received directly from the light client edge device or indirectly from the light client edge device through the local processing device is received first based on a comparison of arrival times at the remote processing device of the signed copies of the control signal received directly from the light client edge device and indirectly from the light client edge device through the local processing device.

As used here, a device, computer, PC, and server are all processing devices that utilize a processor to execute instructions stored in a memory, optionally stored in a non-transitory computer-readable medium and executed via an application resident in one or more of the processing devices.

It will be readily apparent to those of ordinary skill in the art that aspects and concepts of each of the described embodiments may be incorporated, omitted, or combined (in any combination) as desired in a given application, without limitation.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 is a schematic diagram illustrating the operation of the components of the control bifurcation method and system of the present disclosure;

FIG. 2 is another schematic diagram illustrating the operation of the components of the control bifurcation method and system of the present disclosure;

FIG. 3 is a further schematic diagram illustrating the operation of the components of the control bifurcation method and system of the present disclosure, highlighting the processing of the duplicate control signal copies utilized; and

FIG. 4 is a still further schematic diagram illustrating the operation of the components of the control bifurcation method and system of the present disclosure, again highlighting the processing of the control signal from multiple players.

It will be readily apparent to those of ordinary skill in the art that aspects and concepts of each of the illustrated embodiments may be incorporated, omitted, or combined (in any combination) as desired in a given application, without limitation.

### DESCRIPTION

Again, the present disclosure provides control bifurcation methods and systems that utilize duplicated control signals for game streaming, sending one copy from a light client edge device that is playing a game to the local PC that is rendering the game and one copy directly to the remote multi-player server where other players are sending their actions to be sequenced. The local PC that is rendering the game also sends the control signal to the remote multi-player server. The remote multi-player server generates global game state updates with whichever copy of the control signals is received first, either from the light client edge device directly or from the local PC that is rendering the game, discarding any subsequently received duplicate control signal. Control signal latency is thereby minimized. Duplicate control signals are identified based on common control signal signatures that are added to the packet overhead of each control signal at the light client edge device via a game streaming control signal signature application executed at the light client edge device.

In this manner, the control bifurcation method and system eliminate delay by, when faster, enabling control signals to be sent directly from the client, where the gamer is playing, to the multi-player server, when faster, bypassing the need to first transmit these control signals to the PC, where the game is rendered, and then the multi-player server for global game state updates, when slower.

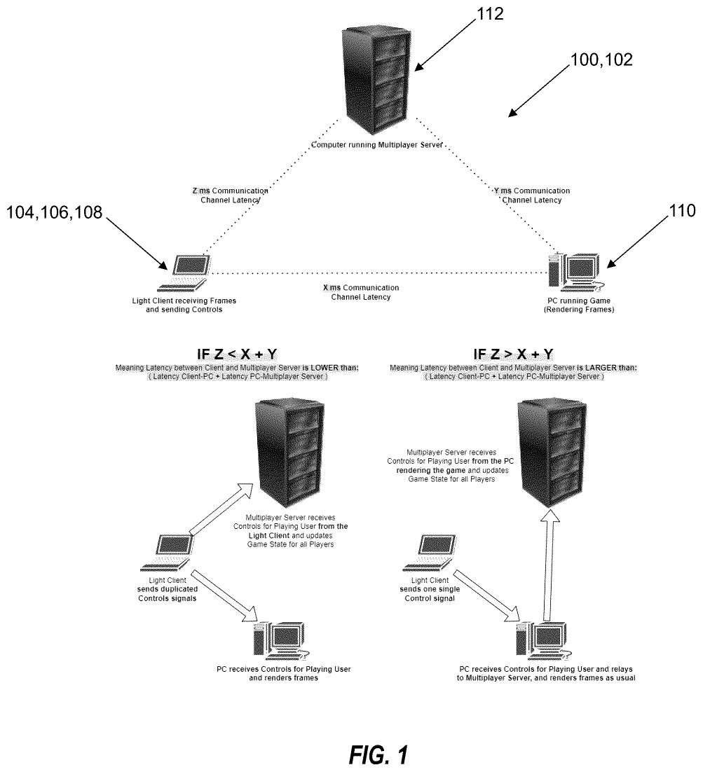

Referring to FIG. 1, the control bifurcation method 100 and system 102 include a light client edge device 104 running a game on a game streaming application 106 connected to an input peripheral 108 that generates an original control signal during game play. This original control signal is duplicated to form a duplicate control signal at the light client edge device 104 via a control signal duplication algorithm of the game streaming application 106, with both copies of the control signal being signed by a control signal signature algorithm of the game streaming application 106 such that they may be correspondingly identified and sequenced. The control signal signature algorithm adds the control signal signatures to the packet overhead of each control signal at the light client edge device 104. In the case of the original control signal and the duplicate control signal, the control signal signatures are the same. The system 102 also includes a local PC 110 in communication with the light client edge device 104 and using the game streaming application 106 that runs the game and renders associated game frames using a received signed copy of the control signal (such as the original control signal or the duplicate control signal). For multi-player gaming, the PC 110 also sends the signed copy of the control signal to a remote multi-player server 112 that is responsible for updating the global game state using the signed copy of the control signal from the PC 110, as well as control signals from other connected gamers playing the game. Because the signed copy of the control signal from the PC 110 has to take multiple hops to reach the multi-player server 112, unoptimized latency may be an issue, with the multi-player server 112 being delayed in receiving the signed copy of the control signal from the PC 110, updating the global game state, and relaying the updated global game state back to the PC 110 for subsequent use by the light client edge device 104. To remedy this problem, the multi-player server 112 also receives a signed copy of the control signal directly from the light client edge device 104 and uses this signed copy of the control signal from the light client edge device 104 if it is received before the signed copy of the control signal from the PC 110. Once any signed copy of the control signal is processed at the multi-player server 112, any subsequently received signed copy of the control signal, as identified by the packet overhead, is disregarded and discarded to eliminate control signal conflicts.

If X ms is the communication channel latency between the light client edge device 104 and the PC 110, Y ms is the communication channel latency between the PC 110 and the multi-player server 112, and Z ms is the communication channel latency between the light client edge device 104 and the multi-player server 112, then two scenarios are possible with respect to which control signal the multi-player server 112 ultimately uses to update the game state for the multiple players. If Z<X+Y, then the multi-player server 112 uses the control signal received directly from the light client edge device 104, discarding any duplicate control signal received from the PC 110. The light client edge device 104 also sends the duplicate control signal to the PC 110 to appropriately render the game frames. If Z>X+Y, then the multi-player server 112 uses the control signal received from the PC 110 and the light client edge device 104, discarding any duplicate control signal received directly from the light client edge device 104. The light client edge device 104 also sends this duplicate control signal to the multi-player server 112 in case this is the control signal to be used. It should be noted that the light client edge device 104 can always send the control signals directly to both the PC 110 and the multi-player server 112 and duplicate control signals can be discarded at the multi-player server 112 based on packet header comparison at the multi-player server 112, or the light client edge device 104 can selectively send a control signal to only the multi-player server 112 or the PC 110 (and then the multi-player server 112) with prior knowledge of the associated communication channel latencies for each full path to the multi-player server 112. This communication channel latency receipt and comparison may be made at the game streaming application 106 of the light client edge device 104.

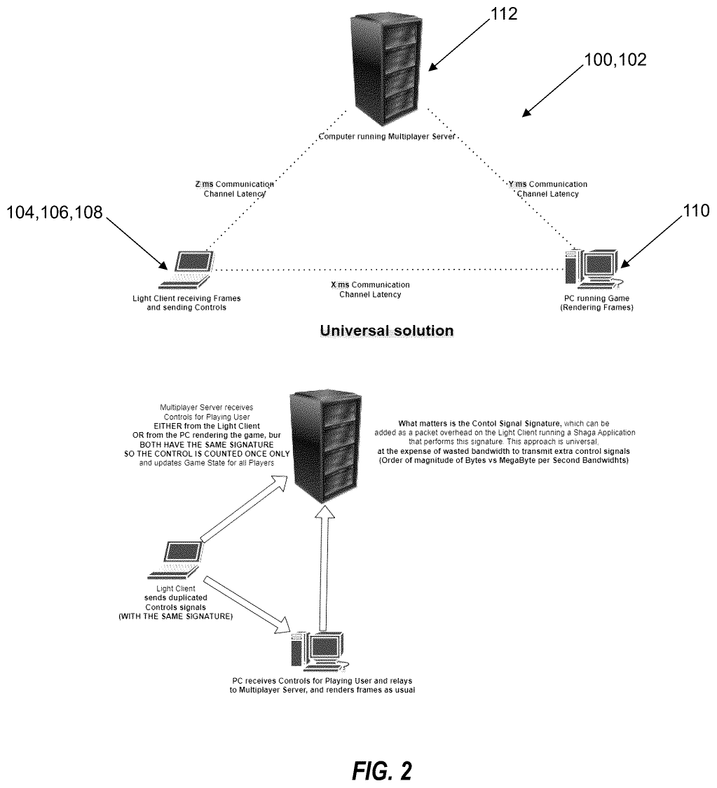

Referring to FIG. 2, again, the control bifurcation method 100 and system 102 include the light client edge device 104 running the game on the game streaming application 106 connected to the input peripheral 108 that generates the original control signal during game play. This original control signal is duplicated to form the duplicate control signal at the light client edge device 104 via the control signal duplication algorithm of the game streaming application 106, with both copies of the control signal being signed by the control signal signature algorithm of the game streaming application 106 such that they may be correspondingly identified and sequenced. The control signal signature algorithm adds the control signal signatures to the packet overhead of each control signal at the light client edge device 104. In the case of the original control signal and the duplicate control signal, the control signal signatures are the same. The system 102 also includes the local PC 110 in communication with the light client edge device 104 and using the game streaming application 106 that runs the game and renders associated game frames using the received signed copy of the control signal (such as the original control signal or the duplicate control signal). For multi-player gaming, the PC 110 also sends the signed copy of the control signal to the remote multi-player server 112 that is responsible for updating the global game state using the signed copy of the control signal from the PC 110, as well as control signals from other connected gamers playing the game. Because the signed copy of the control signal from the PC 110 has to take multiple hops to reach the multi-player server 112, unoptimized latency may be an issue, with the multi-player server 112 being delayed in receiving the signed copy of the control signal from the PC 110, updating the global game state, and relaying the updated global game state back to the PC 110 for subsequent use by the light client edge device 104. To remedy this problem, the multi-player server 112 also receives the signed copy of the control signal directly from the light client edge device 104 and uses this signed copy of the control signal from the light client edge device 104 if it is received before the signed copy of the control signal from the PC 110. Once any signed copy of the control signal is processed at the multi-player server 112, any subsequently received signed copy of the control signal, as identified by the packet overhead, is disregarded and discarded to eliminate control signal conflicts.

Again, if X ms is the communication channel latency between the light client edge device 104 and the PC 110, Y ms is the communication channel latency between the PC 110 and the multi-player server 112, and Z ms is the communication channel latency between the light client edge device 104 and the multi-player server 112, then two scenarios are possible with respect to which control signal the multi-player server 112 ultimately uses to update the game state for the multiple players. If Z<X+Y, then the multi-player server 112 uses the control signal received directly from the light client edge device 104, discarding any duplicate control signal received from the PC 110. The light client edge device 104 also sends the duplicate control signal to the PC 110 to appropriately render the game frames. If Z>X+Y, then the multi-player server 112 uses the control signal received from the PC 110 and the light client edge device 104, discarding any duplicate control signal received directly from the light client edge device 104. The light client edge device 104 also sends this duplicate control signal to the multi-player server 112 in case this is the control signal to be used. It should be noted that the light client edge device 104 can always send the control signals directly to both the PC 110 and the multi-player server 112 and duplicate control signals can be discarded at the multi-player server 112 based on packet header comparison at the multi-player server 112, or the light client edge device 104 can selectively send a control signal to only the multi-player server 112 or the PC 110 (and then the multi-player server 112) with prior knowledge of the associated communication channel latencies for each full path to the multi-player server 112. This communication channel latency receipt and comparison may be made at the game streaming application 106 of the light client edge device 104.

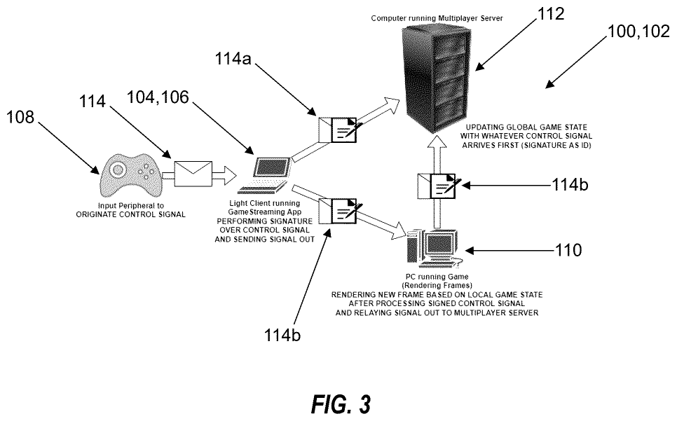

Referring to FIG. 3, again, the control bifurcation method 100 and system 102 include the light client edge device 104 running the game on the game streaming application 106 connected to the input peripheral 108 that generates the original control signal 114 during game play. This original control signal 114 is duplicated to form the duplicate control signals 114a, 114b at the light client edge device 104 via the control signal duplication algorithm of the game streaming application 106, with both copies of the control signal 114a, 114b being signed by the control signal signature algorithm of the game streaming application 106 such that they may be correspondingly identified and sequenced. The control signal signature algorithm adds the control signal signatures to the packet overhead of each control signal 114a, 114b at the light client edge device 104. In the case of the duplicate control signals 114a, 114b, the control signal signatures are the same. The system 102 also includes the local PC 110 in communication with the light client edge device 104 and using the game streaming application 106 that runs the game and renders associated game frames using the received signed copy of the control signal 114b. For multi-player gaming, the PC 110 also sends the signed copy of the control signal 114b to the remote multi-player server 112 that is responsible for updating the global game state using the signed copy of the control signal 114b from the PC 110, as well as control signals from other connected gamers playing the game. Because the signed copy of the control signal 114b from the PC 110 has to take multiple hops to reach the multi-player server 112, unoptimized latency may be an issue, with the multi-player server 112 being delayed in receiving the signed copy of the control signal 114b from the PC 110, updating the global game state, and relaying the updated global game state back to the PC 110 for subsequent use by the light client edge device 104. To remedy this problem, the multi-player server 112 also receives the signed copy of the control signal 114a directly from the light client edge device 104 and uses this signed copy of the control signal 114a from the light client edge device 104 if it is received before the signed copy of the control signal 114b from the PC 110. Once any signed copy of the control signal 114a, 114b is processed at the multi-player server 112, any subsequently received signed copy of the control signal 114a, 114b, as identified by the packet overhead, is disregarded and discarded to eliminate control signal conflicts.

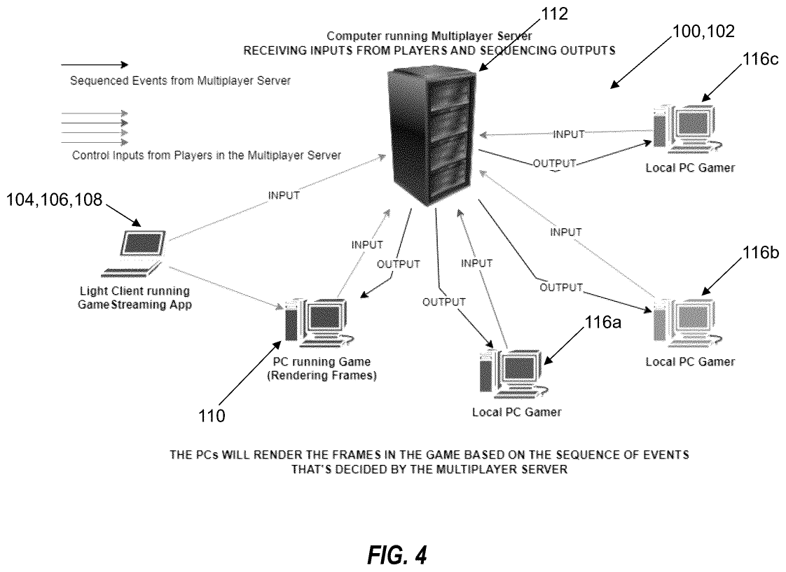

Referring to FIG. 4, again, the control bifurcation method 100 and system 102 include the light client edge device 104 running the game on the game streaming application 106 connected to the input peripheral 108 that generates the original control signal during game play. This original control signal is duplicated to form the duplicate control signals at the light client edge device 104 via the control signal duplication algorithm of the game streaming application 106, with both copies of the control signal being signed by the control signal signature algorithm of the game streaming application 106 such that they may be correspondingly identified and sequenced. The control signal signature algorithm adds the control signal signatures to the packet overhead of each control signal at the light client edge device 104. In the case of the duplicate control signals, the control signal signatures are the same. The system 102 also includes the local PC 110 in communication with the light client edge device 104 and using the game streaming application 106 that runs the game and renders associated game frames using the received signed copy of the control signal. For multi-player gaming, the PC 110 also sends the signed copy of the control signal to the remote multi-player server 112 that is responsible for updating the global game state using the signed copy of the control signal from the PC 110, as well as control signals from other connected gamers playing the game. Because the signed copy of the control signal from the PC 110 has to take multiple hops to reach the multi-player server 112, unoptimized latency may be an issue, with the multi-player server 112 being delayed in receiving the signed copy of the control signal from the PC 110, updating the global game state, and relaying the updated global game state back to the PC 110 for subsequent use by the light client edge device 104. To remedy this problem, the multi-player server 112 also receives the signed copy of the control signal directly from the light client edge device 104 and uses this signed copy of the control signal from the light client edge device 104 if it is received before the signed copy of the control signal from the PC 110. Once any signed copy of the control signal is processed at the multi-player server 112, any subsequently received signed copy of the control signal, as identified by the packet overhead, is disregarded and discarded to eliminate control signal conflicts. As is illustrated, the control signal received from the light client edge device 104, whether directly or indirectly through the PC 110, is sequenced with control signals received from other gaming devices 116a, 116b, 116c and gamers to update the game state, the updated game state then being returned to the PC 110, light client edge device 104, and all other gaming devices 116a, 116b, 116c.

Thus, again, the present disclosure provides control bifurcation methods and systems that utilize duplicated control signals for game streaming, sending one copy from a light client edge device that is playing a game to the local PC that is rendering the game and one copy directly to the remote multi-player server where other players are sending their actions to be sequenced. The local PC that is rendering the game also sends the control signal to the remote multi-player server. The remote multi-player server generates global game state updates with whichever copy of the control signals is received first, either from the light client edge device directly or from the local PC that is rendering the game, discarding any subsequently received duplicate control signal. Control signal latency is thereby minimized. Duplicate control signals are identified based on common control signal signatures that are added to the packet overhead of each control signal at the light client edge device via a game streaming control signal signature application executed at the light client edge device.

In this manner, the control bifurcation method and system eliminate delay by, when faster, enabling control signals to be sent directly from the client, where the gamer is playing, to the multi-player server, when faster, bypassing the need to first transmit these control signals to the PC, where the game is rendered, and then the multi-player server for global game state updates, when slower.

It will be appreciated that some embodiments described may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and/or the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic or circuitry. Of course, a combination of the aforementioned approaches may be used. For some of the embodiments described, a corresponding device in hardware and optionally with software, firmware, and/or a combination thereof can be referred to as “circuitry configured or adapted to,” “logic configured or adapted to,” etc. perform a set of operations, steps, methods, processes, algorithms, functions, techniques, etc. on digital and/or analog signals as described for the various embodiments.

Moreover, some embodiments may include a non-transitory computer readable medium having computer readable code or instructions stored thereon for programming a computer, server, appliance, device, processor, circuit, etc. each of which may include a processor to perform functions as described and claimed. Examples of such computer-readable media include, but are not limited to, a hard disk, an optical storage device, a magnetic storage device, a read only memory (ROM), a programmable read only memory (PROM), an erasable programmable read only memory (EPROM), an electrically erasable programmable read only memory (EEPROM), flash memory, and/or the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described for the various embodiments.

Although the present disclosure is illustrated and described with reference to specific embodiments and examples, it will be readily apparent to those of ordinary skill in the art that other embodiments and examples may perform similar functions and/or achieve like results. All such equivalent embodiments and examples are within the spirit and scope of the present disclosure, are contemplated, and are intended to be covered by the following non-limiting claims for all purposes.

What is claimed is:

1. A control bifurcation method for multi-player game streaming comprising
at a light client edge device, copying and signing a control signal and sending signed copies of the control signal directly to a remote processing device updating a global game state of a game and indirectly to the remote processing device through a local processing device rendering the game, and
at the remote processing device, updating the global game state of the game using one of the signed copies of the control signal received directly from the light client edge device or indirectly from the light client edge device through the local processing device that is received first and disregarding another of the signed copies of the control signal received directly from the light client edge device or indirectly from the light client edge device through the local processing device that is received second.

2. The control bifurcation method of claim 1, wherein the control signal is received at the light client edge device from an input peripheral coupled to the light client edge device.

3. The control bifurcation method of claim 1, wherein the local processing device is a personal computer.

4. The control bifurcation method of claim 1, wherein the remote processing device is a multi-player server.

5. The control bifurcation method of claim 1, wherein the remote processing device updates the global game state of the game using the one of the signed copies of the control signal received directly from the light client edge device or indirectly from the light client edge device through the local processing device that is received first and one or more sequenced control signals received from one or more other gaming devices coupled to the remote processing device and/or the local processing device.

6. The control bifurcation method of claim 1, further comprising, at the remote processing device, determining that the signed copies of the control signal received directly from the light client edge device and indirectly from the light client edge device through the local processing device are copies based on a comparison of packet headers inserted into the signed copies of the control signal received directly from the light client edge device and indirectly from the light client edge device through the local processing device by a game streaming application running in the light client edge device.

7. The control bifurcation method of claim 1, further comprising, at the remote processing device, determining that the one of the signed copies of the control signal received directly from the light client edge device or indirectly from the light client edge device through the local processing device is received first based on a comparison of arrival times at the remote processing device of the signed copies of the control signal received directly from the light client edge device and indirectly from the light client edge device through the local processing device.

8. A control bifurcation system for multi-player game streaming comprising
a light client edge device operable for copying and signing a control signal and sending signed copies of the control signal directly to a remote processing device updating a global game state of a game and indirectly to the remote processing device through a local processing device rendering the game, and
the remote processing device operable for updating the global game state of the game using one of the signed copies of the control signal received directly from the light client edge device or indirectly from the light client edge device through the local processing device that is received first and disregarding another of the signed copies of the control signal received directly from the light client edge device or indirectly from the light client edge device through the local processing device that is received second.

9. The control bifurcation system of claim 8, further comprising an input peripheral coupled to the light client edge device and operable for generating the control signal and sending the control signal to the light client edge device.

10. The control bifurcation system of claim 8, wherein the local processing device is a personal computer.

11. The control bifurcation system of claim 8, wherein the remote processing device is a multi-player server.

12. The control bifurcation system of claim 8, wherein the remote processing device is further operable for updating the global game state of the game using the one of the signed copies of the control signal received directly from the light client edge device or indirectly from the light client edge device through the local processing device that is received first and one or more sequenced control signals received from one or more other gaming devices coupled to the remote processing device and/or the local processing device.

13. The control bifurcation system of claim 8, wherein the remote processing device is further operable for determining that the signed copies of the control signal received directly from the light client edge device and indirectly from the light client edge device through the local processing device are copies based on a comparison of packet headers inserted into the signed copies of the control signal received directly from the light client edge device and indirectly from the light client edge device through the local processing device by a game streaming application running in the light client edge device.

14. The control bifurcation system of claim 8, wherein the remote processing device is further operable for determining that the one of the signed copies of the control signal received directly from the light client edge device or indirectly from the light client edge device through the local processing device is received first based on a comparison of arrival times at the remote processing device of the signed copies of the control signal received directly from the light client edge device and indirectly from the light client edge device through the local processing device.

15. A non-transitory computer-readable medium comprising instructions stored in a memory and executed by a processor to carry out steps of a control bifurcation method for multi-player game streaming comprising
at a light client edge device, copying and signing a control signal and sending signed copies of the control signal directly to a remote processing device updating a global game state of a game and indirectly to the remote processing device through a local processing device rendering the game, and
at the remote processing device, updating the global game state of the game using one of the signed copies of the control signal received directly from the light client edge device or indirectly from the light client edge device through the local processing device that is received first and disregarding another of the signed copies of the control signal received directly from the light client edge device or indirectly from the light client edge device through the local processing device that is received second.

16. The non-transitory computer-readable medium of claim 15, wherein the control signal is received at the light client edge device from an input peripheral coupled to the light client edge device.

17. The non-transitory computer-readable medium of claim 15, wherein the local processing device is a personal computer and the remote processing device is a multi-player server.

18. The non-transitory computer-readable medium of claim 15, wherein the remote processing device updates the global game state of the game using the one of the signed copies of the control signal received directly from the light client edge device or indirectly from the light client edge device through the local processing device that is received first and one or more sequenced control signals received from one or more other gaming devices coupled to the remote processing device and/or the local processing device.

19. The non-transitory computer-readable medium of claim 15, the steps further comprising, at the remote processing device, determining that the signed copies of the control signal received directly from the light client edge device and indirectly from the light client edge device through the local processing device are copies based on a comparison of packet headers inserted into the signed copies of the control signal received directly from the light client edge device and indirectly from the light client edge device through the local processing device by a game streaming application running in the light client edge device.

20. The non-transitory computer-readable medium of claim 15, the steps further comprising, at the remote processing device, determining that the one of the signed copies of the control signal received directly from the light client edge device or indirectly from the light client edge device through the local processing device is received first based on a comparison of arrival times at the remote processing device of the signed copies of the control signal received directly from the light client edge device and indirectly from the light client edge device through the local processing device.
